(19) United States
(12) Patent Application Publication
(10) Pub. No.: US 2012/0008687 A1
(43) Pub. Date: Jan. 12, 2012

(54) VIDEO CODING USING VECTOR QUANTIZED DEBLOCKING FILTERS

(75) Inventor: Barin Geoffry Haskell, Mountain View, CA (US)

(73) Assignee: APPLE INC., Cupertino, CA (US)

(21) Appl. No.: 12/875,052

(22) Filed: Sep. 2, 2010

Related U.S. Application Data
(60) Provisional application No. 61/361,765, filed on Jul. 6, 2010.

(51) Int. Cl. H04N 11/02

(52) U.S. Cl. 375/240.16; 375/E07.209; 375/E07.105; 375/E07.115

(57) ABSTRACT

The present disclosure is directed to use of dynamically assignable deblocking filters as part of video coding/decoding operations. An encoder and a decoder each may store common codebooks that define a variety of deblocking filters that may be applied to recovered video data. During run time coding, an encoder calculates characteristics of an ideal deblocking filter to be applied to a mcblock being coded, one that would minimize coding errors when the mcblock would be recovered at decode. Once the characteristics of the ideal filter are identified, the encoder may search its local codebook to find stored parameter data that best matches parameters of the ideal filter. The encoder may code the reference block and transmit both the coded block and an identifier of the best matching filter to the decoder. The decoder may apply the deblocking filter to mcblock data when the coded block is decoded. If the deblocking filter is part of a prediction loop, the encoder also may apply the deblocking filter to coded mcblock data of reference frames prior to storing the decoded reference frame data in a reference picture cache.

### CROSS-REFERENCE TO RELATED APPLICATIONS

The present application claims the benefit of U.S. Provisional application, Ser. No. 61/361,765 filed Jul. 6, 2010, entitled “VIDEO CODING USING VECTOR QUANTIZED DEBLOCKING FILTERS.” The aforementioned application is incorporated herein by reference in its entirety.

### BACKGROUND

The present invention relates to video coding and, more particularly, to video coding system using deblocking filters as part of video coding.

Video codecs typically code video frames using a discrete cosine transform (“DCT”) on blocks of pixels, called “pixel blocks” herein, much the same as used for the original JPEG coder for still images. An initial frame (called an “intra” frame) is coded and transmitted as an independent frame. Subsequent frames, which are modeled as changing slowly due to small motions of objects in the scene, are coded efficiently in the inter mode using a technique called motion compensation (“MC”) in which the displacement of pixel blocks from their position in previously-coded frames are transmitted as motion vectors together with a coded representation of a difference between a predicted pixel block and a pixel block from the source image.

A brief review of motion compensation is provided below. FIGS. 1 and 2 show block diagrams of a motion-compensated image coder/decoder system. The system combines transform coding (in the form of the DCT of pixel blocks of pixels) with predictive coding (in the form of differential pulse coded modulation (“PCM”)) in order to reduce storage and computation of the compressed image, and at the same time to give a high degree of compression and adaptability. Since motion compensation is difficult to perform in the transform domain, the first step in the interframe coder is to create a motion compensated prediction error. This computation requires one or more frame stores in both the encoder and decoder. The resulting error signal is transformed using a DCT, quantized by an adaptive quantizer, entropy encoded using a variable length coder (“VLC”) and buffered for transmission over a channel.

The way that the motion estimator works is illustrated in FIG. 3. In its simplest form the current frame is partitioned into motion compensation blocks, called “mcblocks” herein, of constant size, e.g., 16×16 or 8×8. However, variable size mcblocks are often used, especially in newer codecs such as H.264. ITU-T Recommendation H.264, Advanced Video Coding. Indeed nonrectangular mcblocks have also been studied and proposed. Mcblocks are generally larger than or equal to pixel blocks in size.

Again, in the simplest form of motion compensation, the previous decoded frame is used as the reference frame, as shown in FIG. 3. However, one of many possible reference frames may also be used, especially in newer codecs such as H.264. In fact, with appropriate signaling, a different reference frame may be used for each mcblock.

Each mcblock in the current frame is compared with a set of displaced mcblocks in the reference frame to determine which one best predicts the current mcblock. When the best matching mcblock is found, a motion vector is determined that specifies the displacement of the reference mcblock.

Exploiting Spatial Redundancy

Because video is a sequence of still images, it is possible to achieve some compression using techniques similar to JPEG. Such methods of compression are called intraframe coding techniques, where each frame of video is individually and independently compressed or encoded. Intraframe coding exploits the spatial redundancy that exists between adjacent pixels of a frame. Frames coded using only intraframe coding are called “I-frames”.

Exploiting Temporal Redundancy

In the unidirectional motion estimation described above, called “forward prediction”, a target mcblock in the frame to be encoded is matched with a set of mcblocks of the same size in a past frame called the “reference frame”. The mcblock in the reference frame that “best matches” the target mcblock is used as the reference mcblock. The prediction error is then computed as the difference between the target mcblock and the reference mcblock. Prediction mcblocks do not, in general, align with coded mcblock boundaries in the reference frame. The position of this best-matching reference mcblock is indicated by a motion vector that describes the displacement between it and the target mcblock. The motion vector information is also encoded and transmitted along with the prediction error. Frames coded using forward prediction are called “P-frames”.

The prediction error itself is transmitted using the DCT-based intraframe encoding technique summarized above.

Bidirectional Temporal Prediction

Bidirectional temporal prediction, also called “Motion-Compensated Interpolation”, is a key feature of modern video codecs. Frames coded with bidirectional prediction use two reference frames, typically one in the past and one in the future. However, two of many possible reference frames may also be used, especially in newer codecs such as H.264. In fact, with appropriate signaling, different reference frames may be used for each mcblock.

A target mcblock in bidirectionally-coded frames can be predicted by a mcblock from the past reference frame (forward prediction), or one from the future reference frame (backward prediction), or by an average of two mcblocks, one from each reference frame (interpolation). In every case, a prediction mcblock from a reference frame is associated with a motion vector, so that up to two motion vectors per mcblock may be used with bidirectional prediction. Motion-Compensated Interpolation for a mcblock in a bidirectionally-predicted frame is illustrated in FIG. 4. Frames coded using bidirectional prediction are called “B-frames”.

Bidirectional prediction provides a number of advantages. The primary one is that the compression obtained is typically higher than can be obtained from forward (unidirectional) prediction alone. To obtain the same picture quality, bidirectionally-predicted frames can be encoded with fewer bits than frames using only forward prediction.

However, bidirectional prediction does introduce extra delay in the encoding process, because frames must be encoded out of sequence. Further, it entails extra encoding complexity because mcblock matching (the most computationally intensive encoding procedure) has to be performed twice for each target mcblock, once with the past reference frame and once with the future reference frame.

Typical Encoder Architecture for Bidirectional Prediction

FIG. 5 shows a typical bidirectional video encoder. It is assumed that frame reordering takes place before coding, i.e., I- or P-frames used for B-frame prediction must be coded and transmitted before any of the corresponding B-frames. In this codec, B-frames are not used as reference frames. With a change of architecture, they could be as in H.264.

Input video is fed to a Motion Compensation Estimator/Predictor that feeds a prediction to the minus input of the subtractor. For each mcblock, the Inter/Intra Classifier then compares the input pixels with the prediction error output of the subtractor. Typically, if the mean square prediction error exceeds the mean square pixel value, an intra mcblock is decided. More complicated comparisons involving DCT of both the pixels and the prediction error yield somewhat better performance, but are not usually deemed worth the cost.

For intra mcblocks the prediction is set to zero. Otherwise, it comes from the Predictor, as described above. The prediction error is then passed through the DCT and quantizer before being coded, multiplexed and sent to the Buffer.

Quantized levels are converted to reconstructed DCT coefficients by the Inverse Quantizer and then the inverse is transformed by the inverse DCT unit (“IDCT”) to produce a coded prediction error. The Adder adds the prediction to the prediction error and clips the result, e.g., to the range 0 to 255, to produce coded pixel values.

For B-frames, the Motion Compensation Estimator/Predictor uses both the previous frame and the future frame kept in picture stores.

For I- and P-frames, the coded pixels output by the Adder are written to the Next Picture Store, while at the same time the old pixels are copied from the Next Picture store to the Previous Picture store. In practice, this is usually accomplished by a simple change of memory addresses.

Also, in practice the coded pixels may be filtered by an adaptive deblocking filter prior to entering the picture stores. This improves the motion compensation prediction, especially for low bit rates where coding artifacts may become visible.

The Coding Statistics Processor in conjunction with the Quantizer Adapter controls the output bit-rate and optimizes the picture quality as much as possible.

Typical Decoder Architecture for Bidirectional Prediction

FIG. 6 shows a typical bidirectional video decoder. It has a structure corresponding to the pixel reconstruction portion of the encoder using inverting processes. It is assumed that frame reordering takes place after decoding and video output. The deblocking filter might be placed at the input to the picture stores as in the encoder, or it may be placed at the output of the adder in order to reduce visible artifacts in the video output.

Fractional Motion Vector Displacements

FIG. 3 and FIG. 4 show reference mcblocks in reference frames as being displaced vertically and horizontally with respect to the position of the current mcblock being decoded in the current frame. The amount of the displacement is represented by a two-dimensional vector [dx, dy], called the motion vector. Motion vectors may be coded and transmitted, or they may be estimated from information already in the decoder, in which case they are not transmitted. For bidirectional prediction, each transmitted mcblock requires two motion vectors.

In its simplest form, dx and dy are signed integers representing the number of pixels horizontally and the number of lines vertically to displace the reference mcblock. In this case, reference mcblocks are obtained merely by reading the appropriate pixels from the reference stores.

However, in newer video codecs it has been found beneficial to allow fractional values for dx and dy. Typically, they allow displacement accuracy down to a quarter pixel, i.e., an integer+−0.25, 0.5 or 0.75.

Fractional motion vectors require more than simply reading pixels from reference stores. In order to obtain reference mcblock values for locations between the reference store pixels, it is necessary to interpolate between them.

Simple bilinear interpolation can work fairly well. However, in practice it has been found beneficial to use two-dimensional interpolation filters especially designed for this purpose. In fact, for reasons of performance and practicality, the filters are often not shift-invariant filters. Instead different values of fractional motion vectors may utilize different interpolation filters.

Deblocking Filter

The deblocking filter is so called because of its function, especially at low bit rates, of smoothing discontinuities at the edges of the mcblocks due to quantization of transform coefficients. It may occur inside the decoding loop of both the encoder and decoder, and/or it may occur as a post-processing operation at the output of the decoder. Luma and chroma values may be deblocked independently or jointly.

In H.264, deblocking is a highly nonlinear and shift-variant pixel processing operation that occurs within the decoding loop. Because it occurs within the decoding loop it must be standardized.

Motion Compensation Using Adaptive Deblocking Filters

The optimum deblocking filter depends on a number of factors. For example, objects in a scene may not be moving in pure translation. There may be object rotation, both in two dimensions and three dimensions. Other factors include zooming, camera motion and lighting variations caused by shadows, or varying illumination.

Camera characteristics may vary due to special properties of their sensors. For example, many consumer cameras are intrinsically interlaced, and their output may be de-interlaced and filtered to provide pleasing-looking pictures free of interlacing artifacts. Low light conditions may cause an increased exposure time per frame, leading to motion dependent blur of moving objects. Pixels may be non-square. Edges in the picture may make directional filters beneficial.

Thus, in many cases improved performance can be had if the deblocking filter can adapt to these and other outside factors. In such systems, deblocking filters may be designed by minimizing the mean square error between the current uncoded mcblocks and deblocked coded mcblocks over each frame. These are the so-called Wiener filters. The filter coefficients would then be quantized and transmitted at the beginning of each frame to be used in the actual motion compensated coding.

The deblocking filter may be thought of as a motion compensation interpolation filter for integer motion vectors. Indeed if the deblocking filter is placed in front of the motion compensation interpolation filter instead of in front of the reference picture stores, the pixel processing is the same. However, the number of operations required may be increased, especially for motion estimation.

### BRIEF DESCRIPTION OF THE DRAWINGS

FIG. 1 is a block diagram of a conventional video coder.

FIG. 2 is a block diagram of a conventional video decoder.

FIG. 3 illustrates principles of motion compensated prediction.

FIG. 4 illustrates principles of bidirectional temporal prediction.

FIG. 5 is a block diagram of a conventional bidirectional video coder.

FIG. 6 is a block diagram of a conventional bidirectional video decoder.

FIG. 7 illustrates an encoder/decoder system suitable for use with embodiments of the present invention.

FIG. 8 is a simplified block diagram of a video encoder according to an embodiment of the present invention.

FIG. 9 illustrates a method according to an embodiment of the present invention.

FIG. 10 illustrates a method according to another embodiment of the present invention.

FIG. 11 is a simplified block diagram of a video decoder according to an embodiment of the present invention.

FIG. 12 illustrates a method according to a further embodiment of the present invention.

FIG. 13 illustrates a codebook architecture according to an embodiment of the present invention.

FIG. 14 illustrates a codebook architecture according to another embodiment of the present invention.

FIG. 15 illustrates a codebook architecture according to a further embodiment of the present invention.

FIG. 16 illustrates a decoding method according to an embodiment of the present invention.

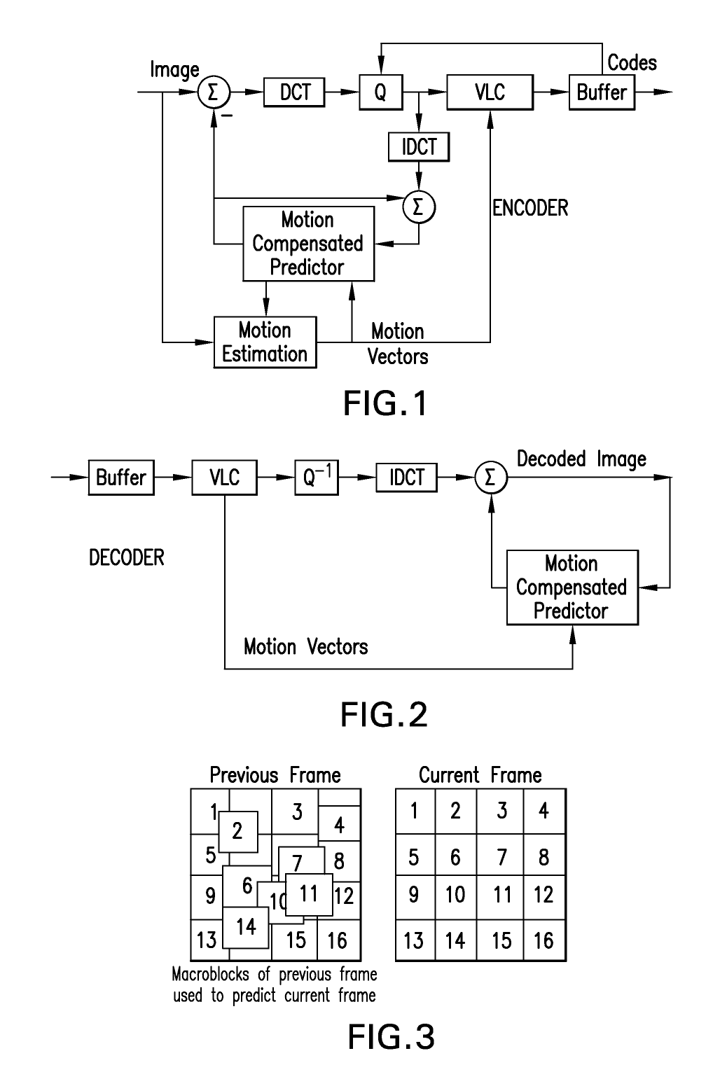

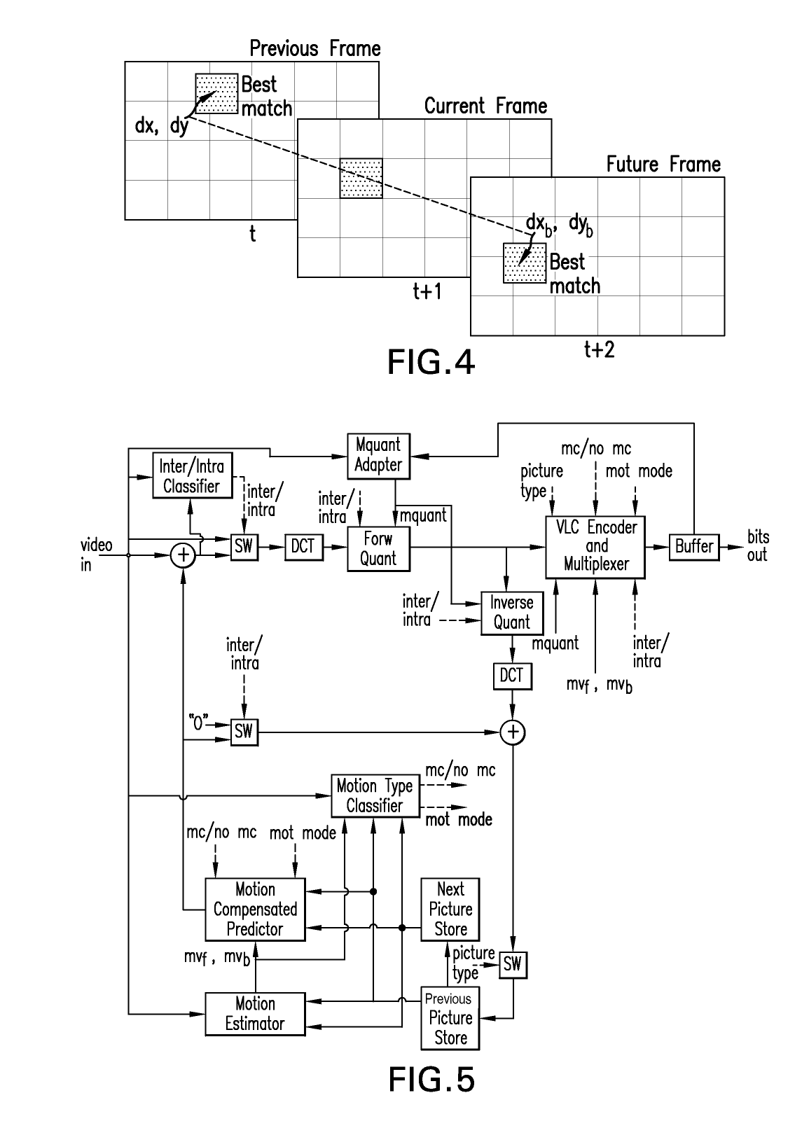

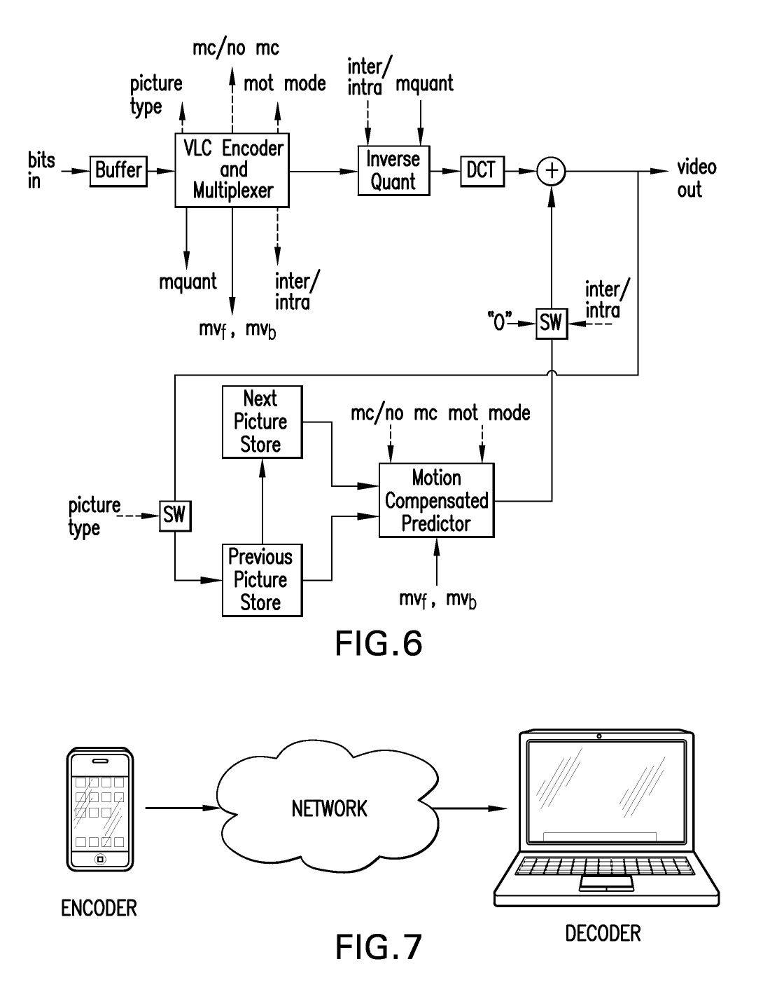

### DETAILED DESCRIPTION

Embodiments of the present invention provide a video coder/decoder system that uses dynamically assignable deblocking filters as part of video coding/decoding operations. An encoder and a decoder each may store common codebooks that define a variety of deblocking filters that may be applied to recovered video data. During run time coding, an encoder calculates characteristics of an ideal deblocking filter to be applied to a mcblock being coded, one that would minimize coding errors when the mcblock would be recovered at decode. Once the characteristics of the ideal filter are identified, the encoder may search its local codebook to find stored parameter data that best matches parameters of the ideal filter. The encoder may code the reference block and transmit both the coded block and an identifier of the best matching filter to the decoder. The decoder may apply the deblocking filter to mcblock data when the coded block is decoded. If the deblocking filter is part of a prediction loop, the encoder also may apply the deblocking filter to coded mcblock data of reference frames prior to storing the decoded reference frame data in a reference picture cache.

Motion Compensation Using Vector Quantized Deblocking Filters—VQDF

Improved codec performance can be achieved if a deblocking filter can be adapted to each mcblock. However, transmitting a filter per mcblock is usually too expensive. Accordingly, embodiments of the present invention propose to use a codebook of filters and send an index into the codebook for each mcblock.

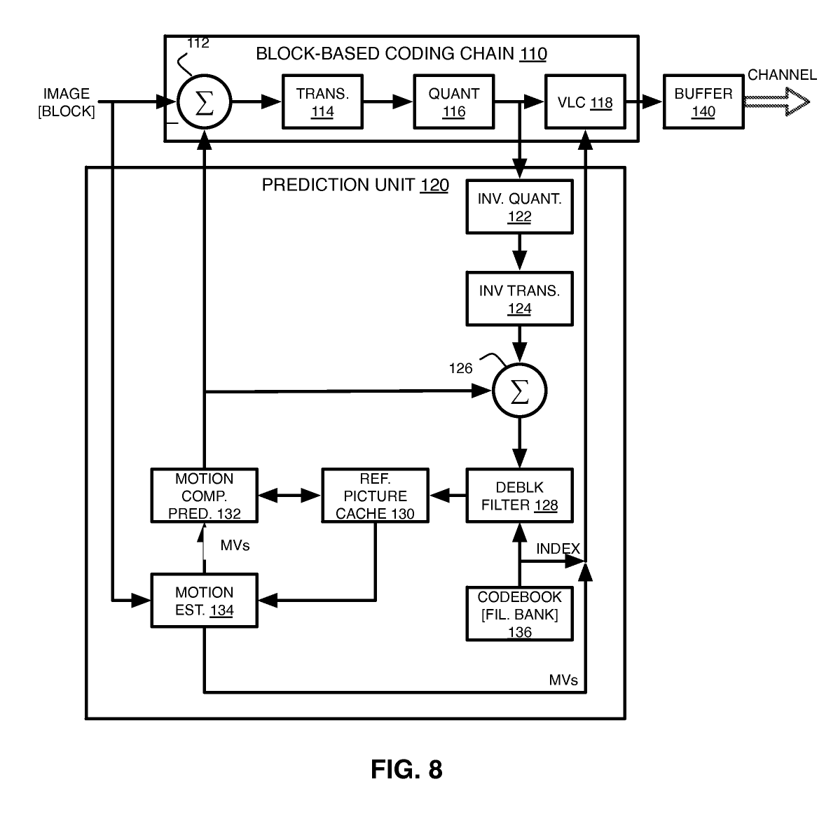

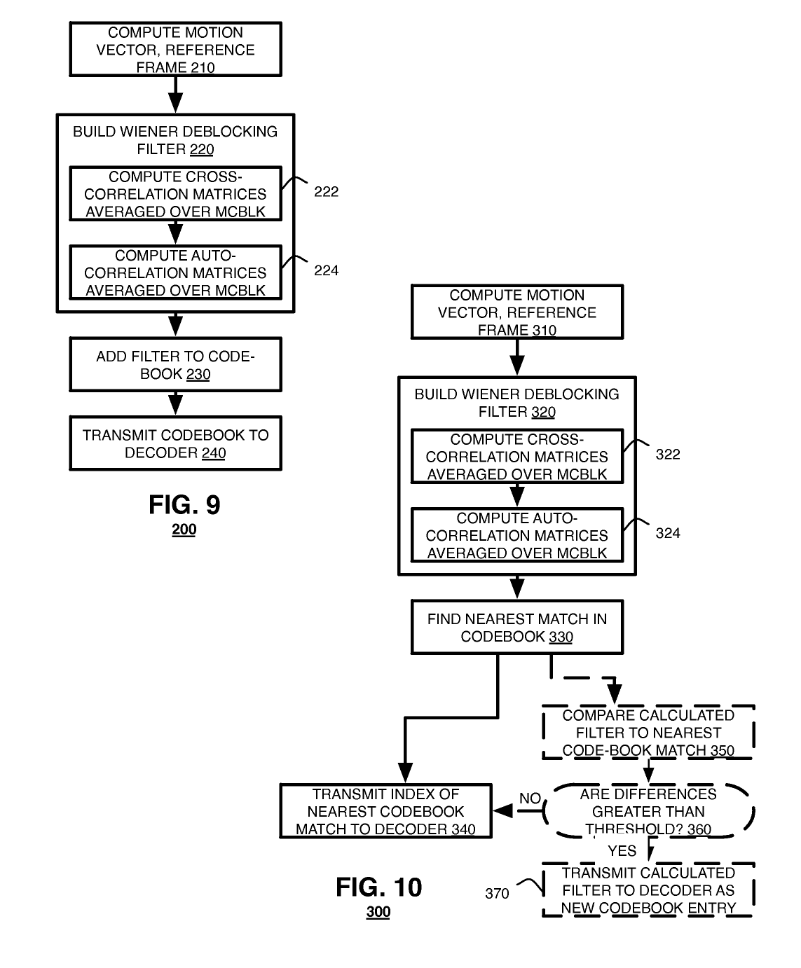

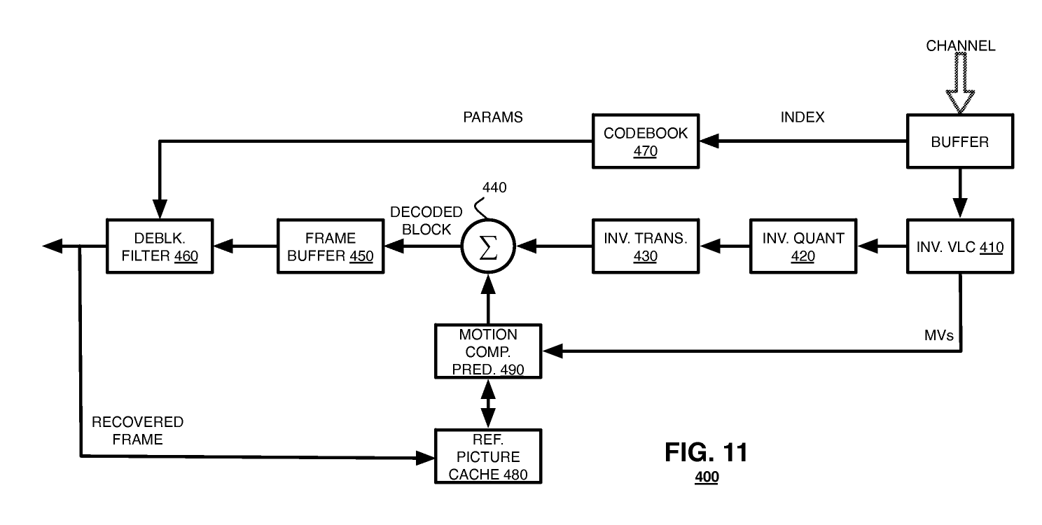

Embodiments of the present invention provide a method of building and applying filter codebooks between an encoder and a decoder (FIG. 7). FIG. 8 illustrates a simplified block diagram of an encoder system showing operation of the deblocking filter. FIG. 9 illustrates a method of building a codebook according to an embodiment of the present invention. FIG. 10 illustrates a method of using a codebook during runtime coding and decoding according to an embodiment of the present invention. FIG. 11 illustrates a simplified block diagram of a decoder showing operation of the deblocking filter and consumption of the codebook indices.

FIG. 8 is a simplified block diagram of an encoder suitable for use with the present invention. The encoder 100 may include a block-based coding chain 110 and a prediction unit 120.

The block-based coding chain 110 may include a subtractor 112, a transform unit 114, a quantizer 116 and a variable length coder 118. The subtractor 112 may receive an input mcblock from a source image and a predicted mcblock from the prediction unit 120. It may subtract the predicted mcblock from the input mcblock, generating a block of pixel residuals. The transform unit 114 may convert the mcblock's residual data to an array of transform coefficient according to a spatial transform, typically a discrete cosine transform (“DCT”) or a wavelet transform. The quantizer 116 may truncate transform coefficients of each block according to a quantization parameter (“QP”). The QP values used for truncation may be transmitted to a decoder in a channel. The variable length coder 118 may code the quantized coefficients according to an entropy coding algorithm, for example, a variable length coding algorithm. Following variable length coding, the coded data of each mcblock may be stored in a buffer 140 to await transmission to a decoder via a channel.

The prediction unit 120 may include: an inverse quantization unit 122, an inverse transform unit 124, an adder 126, a deblocking filter 128, a reference picture cache 130, a motion compensated predictor 132, a motion estimator 134 and a codebook 136. The inverse quantization unit 122 may quantize coded video data according to the QP used by the quantizer 116. The inverse transform unit 124 may transform re-quantized coefficients to the pixel domain. The adder 126 may add pixel residuals output from the inverse transform unit 124 with predicted motion data from the motion compensated predictor 132. The deblocking filter 128 may filter recovered image data at seams between the recovered mcblock and other recovered mcblocks of the same frame. The reference picture cache 130 may store recovered frames for use as reference frames during coding of later-received mcblocks.

The motion compensated predictor 132 may generate a predicted mcblock for use by the block coder. In this regard, the motion compensated predictor may retrieve stored mcblock data of the selected reference frames, and select an interpolation mode to be used and apply pixel interpolation according to the selected mode. The motion estimator 134 may estimate image motion between a source image being coded and reference frame(s) stored in the reference picture cache. It may select a prediction mode to be used (for example, unidirectional P-coding or bidirectional B-coding), and generate motion vectors for use in such predictive coding.

The codebook 136 may store configuration data that defines operation of the deblocking filter 128. Different instances of configuration data are identified by an index into the codebook.

During coding operations, motion vectors, quantization parameters and codebook indices may be output to a channel along with coded mcblock data for decoding by a decoder (not shown).

FIG. 9 illustrates a method according to an embodiment of the present invention. According to the embodiment, a codebook may be constructed by using a large set of training sequences having a variety of detail and motion characteristics. For each mcblock, a motion vector and reference frame may be computed according to traditional techniques (box 210). Then, an N×N Wiener deblocking filter may be constructed (box 220) by computing cross-correlation matrices (box 222) and auto-correlation matrices (box 224) between the uncoded and coded undeblocked mcblocks, each averaged over the mcblock. Alternatively, the cross-correlation matrices and auto-correlation matrices may be averaged over a larger surrounding area having similar motion and detail as the mcblock. The deblocking filter may be a rectangular deblocking filter or a circularly-shaped Wiener deblocking filter.

This procedure may produce auto-correlation matrices that are singular, which means that some of the filter coefficients may be chosen arbitrarily. In these cases, the affected coefficients farthest from the center may be chosen to be zero.

The resulting filter may be added to the codebook (box 230). Filters may be added pursuant to vector quantization (“VQ”) clustering techniques, which are designed to either produce a codebook with a desired number of entries or a codebook with a desired accuracy of representation of the filters. Once the codebook is established, it may be transmitted to the decoder (box 240). After transmission, both the encoder and decoder may store a common codebook, which may be referenced during runtime coding operations.

Transmission to a decoder may occur in a variety of ways. The codebook may then be transmitted periodically to the decoder during encoding operations. Alternatively, the codebook may be coded into the decoder a priori, either from coding operations performed on generic training data or by representation in a coding standard. Other embodiments permit a default codebook to be established in an encoder and decoder but to allow the codebook to be updated adaptively by transmissions from the encoder to the decoder.

Indices into the codebook may be variable length coded based on their probability of occurrence, or they may be arithmetically coded.

FIG. 10 illustrates a method for runtime encoding of video, according to an embodiment of the present invention. For each mcblock to be coded, a motion vector and reference frame(s) may be computed (box 310), coded and transmitted. Then an N×N Wiener deblocking filter may be constructed for the mcblock (box 320) by computing cross-correlation matrices (box 322) and auto-correlation matrices (box 324) averaged over the mcblock. Alternatively, the cross-correlation matrices and auto-correlation matrices may be averaged over a larger surrounding area that has similar motion and detail as the mcblock. The deblocking filter may be a rectangular deblocking filter or a circularly-shaped Wiener deblocking filter.

Once the deblocking filter is established, the codebook may be searched for a previously-stored filter that best matches the newly-constructed deblocking filter (box 330). The matching algorithm may proceed according to vector quantization search methods. When a matching codebook entry is identified, the encoder may code the resulting index and transmit it to a decoder (box 340).

Optionally, in an adaptive process shown in FIG. 10 in phantom, when an encoder identifies a best matching filter from the codebook, it may compare the newly generated deblocking filter with the codebook's filter (box 350). If the differences between the two filters exceed a predetermined error threshold, the encoder may transmit filter characteristics to the decoder, which may cause the decoder to store the characteristics as a new codebook entry (boxes 360-370). If the differences do not exceed the error threshold, the encoder may simply transmit the index of the matching codebook (box 340).

The decoder receives the motion vector, reference frame index and VQ deblocking filter index and may use this data to perform video decoding.

FIG. 11 is a simplified block diagram of a decoder 400 according to an embodiment of the present invention. The decoder 400 may include a variable length decoder 410, an inverse quantizer 420, an inverse transform unit 430, an adder 440, a frame buffer 450, a deblocking filter 460 and codebook 470. The decoder 400 further may include a prediction unit that includes a reference picture cache 480 and a motion compensated predictor 490.

The variable length decoder 410 may decode data received from a channel buffer. The variable length decoder 410 may route coded coefficient data to an inverse quantizer 420, motion vectors to the motion compensated predictor 490 and deblocking filter index data to the codebook unit 470. The inverse quantizer 420 may multiply coefficient data received from the inverse variable length decoder 410 by a quantization parameter. The inverse transform unit 430 may transform dequantized coefficient data received from the inverse quantizer 420 to pixel data. The inverse transform unit 430, as its name implies, performs the converse of transform operations performed by the transform unit of an encoder (e.g., DCT or wavelet transforms). The adder 440 may add, on a pixel-by-pixel basis, pixel residual data obtained by the inverse transform unit 430 with predicted pixel data obtained from the motion compensated predictor 490. The adder 440 may output recovered mcblock data. The frame buffer 450 may accumulate decoded mcblocks and build reconstructed frames therefrom. The deblocking filter 460 may perform deblocking filtering operations on recovered frame data according to filtering parameters received from the codebook. The deblocking filter 460 may output recovered mcblock data, from which a recovered frame may be constructed and rendered at a display device (not shown). The codebook 470 may store configuration parameters for the deblocking filter 460. Responsive to an index received from the channel in association with the mcblock being decoded, stored parameters corresponding to the index are applied to the deblocking filter 460.

Motion compensated prediction may occur via the reference picture cache 480 and a motion compensated predictor 490. The reference picture cache 480 may store recovered image data output by the deblocking filter 460 for frames identified as reference frames (e.g., decoded I- or P-frames). The motion compensated predictor 490 may retrieve reference mcblock(s) from the reference picture cache 480, responsive to mcblock motion vector data received from the channel. The motion compensated predictor may output the reference mcblock to the adder 440.

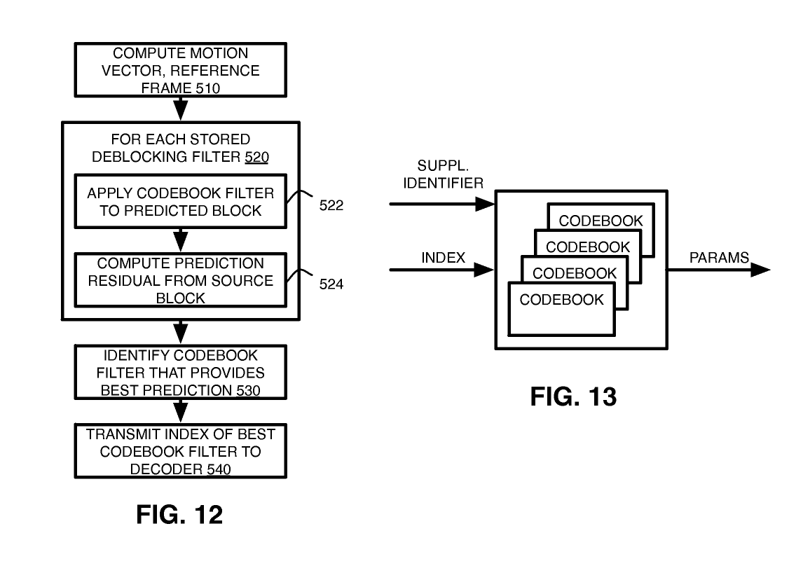

FIG. 12 illustrates a method according to another embodiment of the present invention. For each mcblock, a motion vector and reference frame may be computed according to traditional techniques (box 510). Then, an N×N Wiener deblocking filter may be selected by serially determining coding results that would be obtained by each filter stored in the codebook (box 520). Specifically, for each mcblock, the method may perform filtering operations on a predicted block using either all or a subset of the filters in succession (box 522) and estimate a prediction residual therefrom (box 524). The method may determine which filter configuration gives the best prediction (box 530). The index of that filter may be coded and transmitted to a decoder (box 540). This embodiment conserves processing resources that otherwise might be spent computing Wiener filters for each source mcblock.

Simplifying Calculation of Wiener Filters

In another embodiment, select filter coefficients may be forced to be equal to other filter coefficients. This embodiment can simplify the calculation of Wiener filters.

Derivation of a Wiener filter for a mcblock involves derivation of an ideal N×1 filter F according to:

F=S⁻¹R

that minimizes the mean squared prediction error. For each pixel p in the mcblock, the matrix F yields a deblocked pixel \hat{p} by \hat{p}=F^{T}·Qₚ and a coding error represented by err=p−\hat{p}.

More specifically, for each pixel p, the vector Qₚ may take the form:

$${Q}_{p} = [ \begin{matrix}{q}_{1} \\ {q}_{2} \\ ⋮ \\ {q}_{N}\end{matrix} ] ,$$

where q₁ to q_{N} represent pixels in or near the coded undeblocked mcblock to be used in the deblocking of p.

In the foregoing, R is an N×1 cross-correlation matrix derived from uncoded pixels (p) to be coded and their corresponding Qₚ vectors. In the R matrix, ri at each location i may be derived as p·qi averaged over the pixels p in the mcblock. S is an N×N auto-correlation matrix derived from the N×1 vectors Qₚ. In the S matrix, si,j at each location i,j may be derived as qi·qj averaged over the pixels p in the mcblock. Alternatively, the cross-correlation matrices and auto-correlation matrices may be averaged over a larger surrounding area having similar motion and detail as the mcblock.

Derivation of the S and R matrices occurs for each mcblock being coded. Accordingly, derivation of the Wiener filters involves substantial computational resources at an encoder. According to this embodiment, select filter coefficients in the F matrix may be forced to be equal to each other, which reduces the size of F and, as a consequence, reduces the computational burden at the encoder. Consider an example where filter coefficients f₁ and f₂ are set to be equal to each other. In this embodiment, the F and Qₚ matrices may be modified as:

$$F = [ \begin{matrix}{f}_{1} \\ {f}_{3} \\ ⋮ \\ {f}_{N}\end{matrix} ] and {Q}_{p} = [ \begin{matrix}{q}_{1} + {q}_{2} \\ {q}_{3} \\ ⋮ \\ {q}_{N}\end{matrix} ] .$$

Deletion of the single coefficient reduces the size of F and Qₚ both to N−1×1. Deletion of other filter coefficients in F and consolidation of values in Qₚ can result in further reductions to the sizes of the F and Qₚ vectors. For example, it often is advantageous to delete filter coefficients at all positions (save one) that are equidistant to each other from the pixel p. In this manner, derivation of the F matrix is simplified.

In another embodiment, encoders and decoders may store separate codebooks that are indexed not only by the filter index but also by supplemental identifiers (FIG. 13). In such embodiments, the supplemental identifiers may select one of the codebooks as being active and the index may select an entry from within the codebook to be output to the deblocking filter.

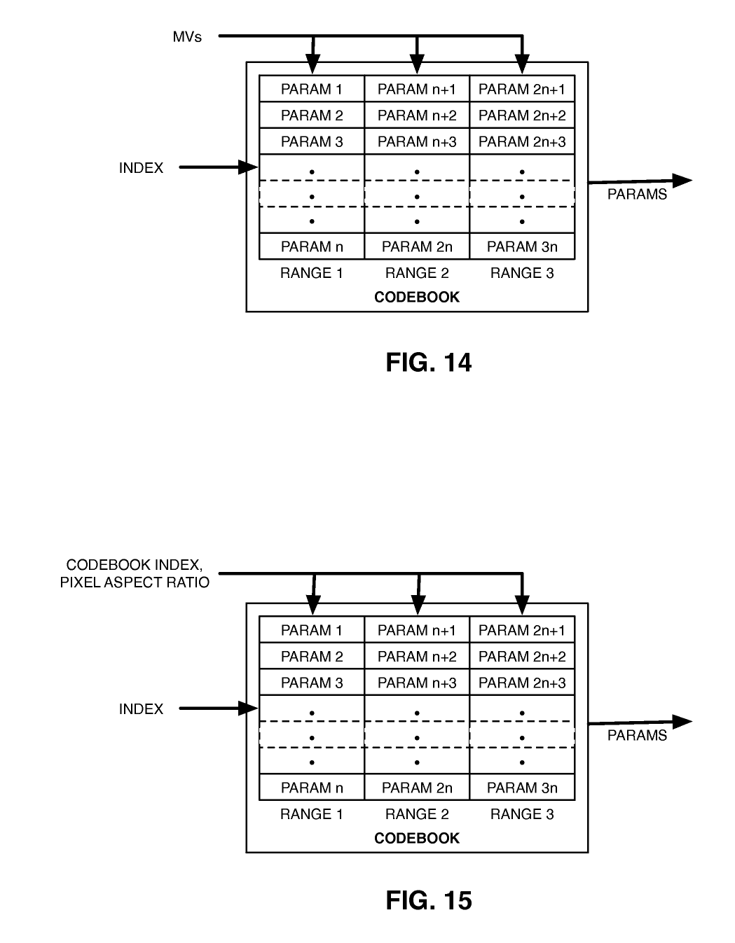

The supplemental identifier may be derived from many sources. In one embodiment, a block's motion vector may serve as the supplemental identifier. Thus, separate codebooks may be provided for each motion vector value or for different ranges of motion vectors (FIG. 14). Then in operation, given the motion vector and reference frame index, the encoder and decoder both may use the corresponding codebook to recover the filter to be used in deblocking.

In a further embodiment, separate codebooks may be constructed for each value or range of values of the distance of the pixel to be filtered from the edge of the dctblock (the blocks output from the DCT decode). Then in operation, given the distance of the pixel to be filtered from the edge of the dctblock, the encoder and decoder use the corresponding codebook to recover the filter to be used in deblocking.

In another embodiment, separate codebooks may be provided for different values or ranges of values of motion compensation interpolation filters present in the current or reference frame. Then in operation, given the values of the interpolation filters, the encoder and decoder use the corresponding codebook to recover the filter to be used in deblocking.

In a further embodiment, shown in FIG. 15, separate codebooks may be provided for different values or ranges of values of other codec parameters such as pixel aspect ratio and bit rate. Then in operation, given the values of these other codec parameters, the encoder and decoder use the corresponding codebook to recover the filter to be used in deblocking.

In another embodiment, separate codebooks may be provided for P-frames and B-frames or, alternatively, for coding types (P- or B-coding) applied to each mcblock.

In a further embodiment, different codebooks may be generated from discrete sets of training sequences. The training sequences may be selected to have consistent video characteristics within the feature set, such as speeds of motion, complexity of detail and/or other parameters. Then separate codebooks may be constructed for each value or range of values of the feature set. Features in the feature set, or an approximation thereto, may be either coded and transmitted or, alternatively, derived from coded video data as it is received at the decoder. Thus, the encoder and decoder will store common sets of codebooks, each tailored to characteristics of the training sequences from which they were derived. In operation, for each mcblock, the characteristics of input video data may be measured and compared to the characteristics that were stored from the training sequences. The encoder and decoder may select a codebook that corresponds to the measured characteristics of the input video data to recover the filter to be used in deblocking. In a further embodiment, separate codebooks may be constructed for each value or range of values of the distance of the pixel to be filtered from the edge of the dctblock (the blocks output from the DCT decode). Then in operation, given the distance of the pixel to be filtered from the edge of the dctblock, the encoder and decoder use the corresponding codebook to recover the filter to be used in deblocking.

In yet another embodiment, an encoder may construct separate codebooks arbitrarily and switch among the codebooks by including an express codebook specifier in the channel data.

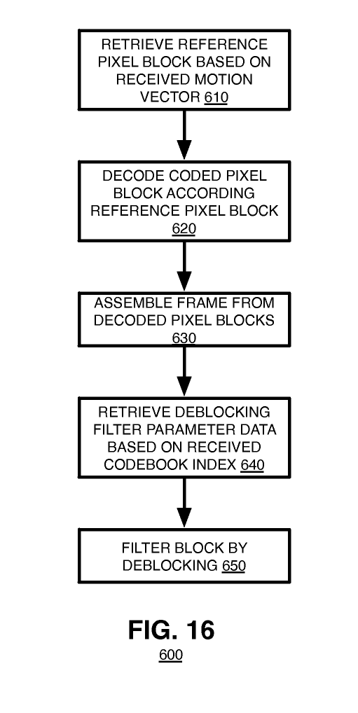

FIG. 16 illustrates a decoding method 600 according to an embodiment of the present invention. The method 600 may be repeated for each coded mcblock received by a decoder from a channel. According to the method, a decoder may retrieve data of a reference mcblock based on a motion vector received from the channel for the coded mcblock (box 610). The decoder may decode the coded mcblock with reference to the reference mcblock via motion compensation (box 620). Thereafter, the method may build a frame from decoded mcblocks (box 630). After the frame is assembled, the method may perform deblocking on the decoded mcblocks in the frame. For each mcblock, the method may retrieve filtering parameters from the code book (box 640) and filter the mcblock accordingly (box 650). Having filtered the frame, the frame may be rendered on a display or stored, if appropriate, as a reference frame for decoding of subsequently-received frames.

Minimizing Mean Square Error Between Filtered Current Mcblocks and their Corresponding Reference Mcblocks

Normally, deblocking filters may be designed by minimizing the mean square error between the uncoded and deblocked coded current mcblocks over each frame or part of a frame. In an embodiment, the deblocking filters may be designed to minimize the mean square error between filtered uncoded current mcblocks and deblocked coded current mcblocks over each frame or part of a frame. The filters used to filter the uncoded current mcblocks need not be standardized or known to the decoder. They may adapt to parameters such as those mentioned above, or to others unknown to the decoder such as level of noise in the incoming video. They may emphasize high spatial frequencies in order to give additional weighting to sharp edges.

The foregoing discussion identifies functional blocks that may be used in video coding systems constructed according to various embodiments of the present invention. In practice, these systems may be applied in a variety of devices, such as mobile devices provided with integrated video cameras (e.g., camera-enabled phones, entertainment systems and computers) and/or wired communication systems such as videoconferencing equipment and camera-enabled desktop computers. In some applications, the functional blocks described hereinabove may be provided as elements of an integrated software system, in which the blocks may be provided as separate elements of a computer program. In other applications, the functional blocks may be provided as discrete circuit components of a processing system, such as functional units within a digital signal processor or application-specific integrated circuit. Still other applications of the present invention may be embodied as a hybrid system of dedicated hardware and software components. Moreover, the functional blocks described herein need not be provided as separate units. For example, although FIG. 8 illustrates the components of the block-based coding chain 110 and prediction unit 120 as separate units, in one or more embodiments, some or all of them may be integrated and they need not be separate units. Such implementation details are immaterial to the operation of the present invention unless otherwise noted above.

Several embodiments of the invention are specifically illustrated and/or described herein. However, it will be appreciated that modifications and variations of the invention are covered by the above teachings and within the purview of the appended claims without departing from the spirit and intended scope of the invention.

We claim:

1. A video encoder, comprising:
a block-based coding unit to code input pixel block data according to motion compensation,
a prediction unit to generate reference pixel blocks for use in the motion compensation, the prediction unit comprising:
decoding units to invert coding operations of the block-based coding unit,
a reference picture cache for storage of reference pictures,
a deblocking filter to perform filtering on data output by the decoding units, and
a codebook to store sets of parameter data to configure operation of the deblocking filter, each set of parameter data identifiable by a respective codebook index.

2. The video encoder of claim 1, wherein the codebook is a multi-dimensional codebook, indexed also by a codebook identifier.

3. The video encoder of claim 1, wherein the codebook is a multi-dimensional codebook, indexed also by a motion vector calculated for an input pixel block.

4. The video encoder of claim 1, wherein the codebook is a multi-dimensional codebook, indexed also by an aspect ratio calculated for an input pixel block.

5. The video encoder of claim 1, wherein the codebook is a multi-dimensional codebook, indexed also by coding type assigned to an input pixel block.

6. The video encoder of claim 1, wherein the codebook is a multi-dimensional codebook, indexed also by an indicator of an input pixel block's complexity.

7. The video encoder of claim 1, wherein the codebook is a multi-dimensional codebook, indexed also by an encoder bit rate.

8. The video encoder of claim 1, wherein the codebook is a multi-dimensional codebook, each dimension generated from a respective set of training sequences.

9. The video encoder of claim 1, wherein the codebook is a multi-dimensional codebook, each dimension associated with respective values of interpolation filter indicators.

10. A video coding method, comprising:
coding an input pixel block data according to motion compensated prediction,
decoding coded pixel block data of reference frames, the decoding including:
inverting coding of the reference frame pixel block data to obtain decoded pixel data of the block,
calculating characteristics of an ideal filter for deblocking the decoded reference frame pixel block,
searching a codebook of previously-stored filter characteristics to identify a matching codebook filter,
if a match is found, filtering the decoded pixel block by the matching codebook filter and storing the decoded pixel block as reference frame data, and
transmitting coded data of the input pixel block and an identifier of the matching codebook filter to a decoder.

11. The video coding method of claim 10, further comprising, if a match is not found:
coding the input pixel block with respect to the reference pixel block having been filtered by the calculated codebook filter, and
transmitting coded data of the input pixel block and data identifying characteristics of the calculated codebook filter to a decoder.

12. The video coding method of claim 10, further comprising, if a match is not found:
coding the input pixel block with respect to the reference pixel block having been filtered by a nearest-matching codebook filter, and
transmitting coded data of the input pixel block and an identifier of the nearest-matching codebook filter to a decoder.

13. The video coding method of claim 10, wherein the codebook is a multi-dimensional codebook, indexed also by a codebook identifier.

14. The video coding method of claim 10, wherein the codebook is a multi-dimensional codebook, indexed also by a motion vector calculated for the input block.

15. The video coding method of claim 10, wherein the codebook is a multi-dimensional codebook, indexed also by an aspect ratio calculated for the input block.

16. The video coding method of claim 10, wherein the codebook is a multi-dimensional codebook, indexed also by coding type assigned to the input block.

17. The video coding method of claim 10, wherein the codebook is a multi-dimensional codebook, indexed also by an indicator of the input block's complexity.

18. The video coding method of claim 10, wherein the codebook is a multi-dimensional codebook, indexed also by an encoder bit rate.

19. The video coding method of claim 10, wherein the codebook is a multi-dimensional codebook, each dimension generated from a respective set of training sequences.

20. The video encoder of claim 10, wherein the codebook is a multi-dimensional codebook, each dimension associated with respective values of interpolation filter indicators.

21. A video coder control method, comprising:
coding an input pixel block data according to motion compensated prediction,
decoding coded pixel block data of reference frames, the decoding including:
inverting coding of the reference frame pixel block data to obtain decoded pixel data of the block,
calculating characteristics of an ideal filter for deblocking the decoded reference frame pixel block,
searching a codebook of previously-stored filter characteristics to identify a matching codebook filter, and
if no match is found, adding the characteristics of the ideal filter to the codebook.

22. The method of claim 21, further comprising:
repeating the method over a predetermined set of training data,
after the training data has been processed, transmitting the codebook to a decoder.

23. The method of claim 21, further comprising:
repeating the method over a sequence of video data, and
each time a new filter is added to the codebook, transmitting characteristics of the filter to a decoder.

24. The method of claim 21, further comprising:
if a match is found, coding the input pixel block with respect to the reference pixel block having been filtered by the matching codebook filter, and
transmitting coded data of the input pixel block and an identifier of the matching codebook filter to a decoder.

25. The method of claim 21, wherein the codebook is a multi-dimensional codebook, the method further comprising:
repeating the method over plural sets of training data, each set of training data having similar motion characteristics, and
building respective dimensions of the codebook therefrom.

26. The method of claim 21, wherein the codebook is a multi-dimensional codebook, the method further comprising:
repeating the method over plural sets of training data, each set of training data having similar image complexity, and
building respective dimensions of the codebook therefrom.

27. The method of claim 21, wherein the codebook is a multi-dimensional codebook, indexed also by a codebook identifier.

28. A video coding method, comprising:
coding an input pixel block data according to motion compensated prediction,
decoding coded pixel block data of reference frames, the decoding including:
inverting coding of the reference frame pixel block data to obtain decoded pixel data of the block,
iteratively, filtering the decoded reference pixel block by each of a plurality of candidate filter configurations stored in a codebook, and
identifying an optimal filtering configuration for the decoded reference pixel block from the filtered blocks; and
transmitting coded data of the input pixel block and a codebook identifier corresponding to the final filtering configuration.

29. A video decoder, comprising:
a block-based decoder to decode coded pixel blocks by motion compensated prediction,
a frame buffer to accumulate decoded pixel blocks as frames,
a deblocking filter to filter decoded pixel block data according to filtering parameters,
a codebook to store sets of parameter data and, responsive to codebook indices received with respective coded pixel blocks, to supply parameter data referenced by the indices to the deblocking filter.

30. The video decoder of claim 29, wherein the codebook is a multi-dimensional codebook, indexed also by a codebook identifier.

31. The video decoder of claim 29, wherein the codebook is a multi-dimensional codebook, indexed also by a motion vector of the coded pixel block.

32. The video decoder of claim 29, wherein the codebook is a multi-dimensional codebook, indexed also by a pixel aspect ratio.

33. The video decoder of claim 29, wherein the codebook is a multi-dimensional codebook, indexed also by coding type of the coded pixel block.

34. The video decoder of claim 29, wherein the codebook is a multi-dimensional codebook, indexed also by an indicator of the coded pixel block's complexity.

35. The video decoder of claim 29, wherein the codebook is a multi-dimensional codebook, indexed also by a bit rate of coded video data.

36. A video decoding method, comprising:
decoding received coded pixel block data according to motion compensated prediction,
retrieving filter parameter data from a codebook store according to a codebook index received with the coded pixel block data, and
filtering the decoded pixel block data according to the parameter data.

37. The method of claim 36, wherein the codebook is a multi-dimensional codebook, indexed also by a codebook identifier.

38. The method of claim 36, wherein the codebook is a multi-dimensional codebook, indexed also by a motion vector of the coded pixel block.

39. The method of claim 36, wherein the codebook is a multi-dimensional codebook, indexed also by a pixel aspect ratio.

40. The method of claim 36, wherein the codebook is a multi-dimensional codebook, indexed also by a coding type of the coded pixel block.

41. The method of claim 36, wherein the codebook is a multi-dimensional codebook, indexed also by an indicator of the coded pixel block's complexity.

42. The method of claim 36, wherein the codebook is a multi-dimensional codebook, indexed also by a bit rate of coded video data.

43. The method of claim 36, wherein the codebook is a multi-dimensional codebook, each dimension associated with respective values of interpolation filter indicators.

44. Computer readable media having program instructions stored thereon that, when executed by a processing device, cause the device to:
code an input pixel block data according to motion compensated prediction;
decode coded pixel block data of reference frames, the decoding including:
inverting coding of the reference frame pixel block data to obtain decoded pixel data of the block,
calculating characteristics of an ideal filter for deblocking the decoded reference frame pixel block,
searching a codebook of previously-stored filter characteristics to identify a matching codebook filter, and
if a match is found, filtering the decoded pixel block by the matching codebook filter and storing the decoded pixel block as reference frame data; and
transmit coded data of the input pixel block and an identifier of the matching codebook filter to a decoder.

45. A coded video signal, carried on a physical transmission medium, generated according to the process of:
coding an input pixel block data according to motion compensated prediction,
decoding coded pixel block data of reference frames, the decoding including:
inverting coding of the reference frame pixel block data to obtain decoded pixel data of the block,
calculating characteristics of an ideal filter for deblocking the decoded reference frame pixel block,
searching a codebook of previously-stored filter characteristics to identify a matching codebook filter,
if a match is found, filtering the decoded pixel block by the matching codebook filter and storing the decoded pixel block as reference frame data, and
transmitting coded data of the input pixel block and an identifier of the matching codebook filter to a decoder.

46. Computer readable media having program instructions stored thereon that, when executed by a processing device, cause the device to:
decode received coded pixel block data according to motion compensated prediction,
retrieve filter parameter data from a codebook store according to a codebook index received with the coded pixel block data, and
filter the decoded pixel block data according to the parameter data.
